(19) United States
(12) Patent Application Publication
(10) Pub. No.: US 2018/0293651 A1
(43) Pub. Date: Oct. 11, 2018

(54) INTELLECTUAL PROPERTY TRANSACTION SYSTEM AND INTELLECTUAL PROPERTY TRANSACTION METHOD

(71) Applicant: OPTiM Corporation, Saga-shi (JP)

(72) Inventor: Shunji SUGAYA, Tokyo (JP)

(21) Appl. No.: 16/005,879

(22) Filed: Jun. 12, 2018

Related U.S. Application Data
(63) Continuation of application No. PCT/JP2016/085567, filed on Nov. 30, 2016.

(51) Int. Cl. G06Q 40/04; G06Q 30/06; G06Q 50/18

(52) U.S. Cl. CPC G06Q 40/04; G06Q 50/184; G06Q 30/0601

(57) ABSTRACT

The present invention is an intellectual property transaction system and an intellectual property transaction method that transact a license of intellectual property by receiving information from each of the exhibitor, the purchaser, and the seller. The intellectual property transaction system receives input of information on a license of intellectual property and a selling price for the license from an exhibitor's terminal, receives input of a purchase price for the input information on the license of intellectual property from a purchaser's terminal, and performs a sale process if the selling price corresponds to the purchase price. Then, the intellectual property transaction system receives input of the sales price of the license of intellectual property to be sold among the exhibited licenses of the intellectual property from a seller's terminal if the purchaser becomes a seller and performs a sale process if the purchase price corresponds to the sales price.

### CROSS REFERENCE TO RELATED APPLICATION

This application is a continuation of PCT Application No. PCT/JP2016/085567, filed on Nov. 30, 2016, the entire contents of which are incorporated herein by reference.

### TECHNICAL FIELD

The present invention relates to an intellectual property transaction system and an intellectual property transaction method for transacting a license of intellectual property.

### BACKGROUND ART

Recently, intellectual property has been transacted by using a system in order to attempt to distribute intellectual property. For example, an intellectual property market system that is capable to safely distribute intellectual property that requires its secrecy in a virtual marketplace on a public network is provided (Patent Document 1).

### CITATION LIST

### Patent Literature

Patent Document 1: JP 2008-27087A

### SUMMARY OF INVENTION

The system of Patent Document 1 ensures safety in some degree but does not provide enough liquid to a license of intellectual property. For example, since the person who put intellectual property on the market tends to increase the sales price, intellectual property does not have much opportunity to be distributed to others.

For example, like the stock market that separates cooperates from stock trading firms, the inventor focused on the fact that dividing ones who put a license of intellectual property on the market from ones who sell it may be able to provide the liquidity of a license of intellectual property to the market.

Since the license of intellectual property is not just a right but a right for licensing, countless licenses except exclusive licenses can be generated. Therefore, the market may have liquidity considering such flexibility.

In view of the above-mentioned problems, an objective of the present invention relates to an intellectual property transaction system and an intellectual property transaction method that achieve transaction of a license of intellectual property with high flexibility by receiving information from each of the exhibitor, the purchaser, and the seller.

The present invention provides an intellectual property transaction system for transacting a license of intellectual property, including: an information receiving unit that receives input of information on a license of intellectual property and a selling price for the license from an exhibitor's terminal; a purchase receiving unit that receives input of a purchase price for the input information on the license of intellectual property from a purchaser's terminal; and a sales receiving unit that receives input of a sales price for a license of intellectual property to be sold among the exhibited licenses of the intellectual property from a seller's terminal if the purchaser becomes a seller, wherein the system performs a sale process for the purchaser if the selling price corresponds to the purchase price, and the system performs a sale process if the purchase price corresponds to the sales price.

The present invention can transact a license of intellectual property with high flexibility by receiving information from each of the exhibitor, the purchaser, and the seller like stock trading.

### BRIEF DESCRIPTION OF THE DRAWINGS

FIG. 1 is a diagram for explaining an overview of an intellectual property transaction system according to an embodiment of the present invention.

FIG. 2 is a diagram showing a flowchart of an intellectual property transaction processing executed by an intellectual property transaction system according to an embodiment of the present invention.

### DESCRIPTION OF EMBODIMENTS

Embodiments of the present invention will be described below. However, this is illustrative only, and the technological scope of the present invention is not limited thereto.

The intellectual property transaction system transacts a license of intellectual property. The use of the term “license” herein limits intellectual property to patents, utility model rights, design rights, breeder's rights, knowhow, trade secrets, etc. However, the license may be used for trademark rights, etc., in application on use rights or may be used for copyrights as license rights.

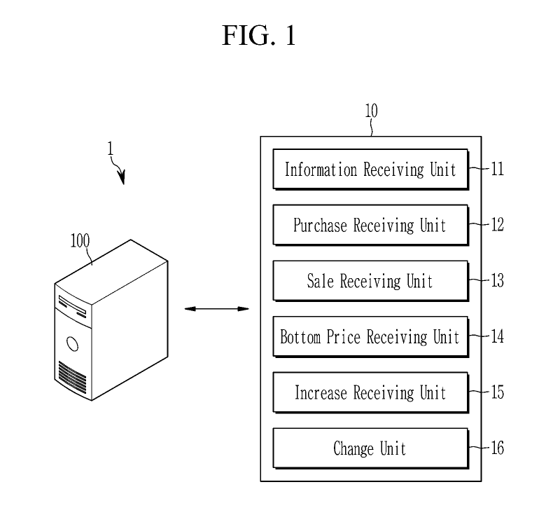

FIG. 1 is a diagram for explaining an overview of an intellectual property transaction system 1 according to an embodiment of the present invention. Referring to FIG. 1, the intellectual property transaction system 1 includes terminals 10 (computers that an exhibitor, a purchaser, and a seller use) and a management computer 100 that communicates with each terminal. The terminals include an information receiving unit 11, a purchase receiving unit 12, a sale receiving unit 13, a bottom price receiving unit 14, an increase receiving unit 15, and a change unit 16 that are achieved by reading a predetermined program to one or more control units such as processors.

In the intellectual property transaction system 1, the management computer 100 receives data transmitted from the terminals 10, stores information on a license and predetermined prices (e.g., purchase price, sales price), and performs a sale process if the prices correspond to each other.

The management computer 100 may be achieved by a single computer or two or more computers.

The management computer 100 receives and stores information on a license (the type, the name, and the number of licenses) and the selling price that are input from an exhibitor's terminal 10, receives the purchase price and the sales price from a purchaser's terminal 10 and a seller's terminal 10, respectively, and performs a sale process for the purchaser and the seller. The sale process grants an exhibitor's permission (license) to a purchaser or a seller on a purchase price or a sales price.

The exhibitor and the seller may be the same, and the exhibitor's terminal 10 and the seller's terminal 10 may also be the same accordingly. However, the seller is distinguished herein from the exhibitor in order to improve the market liquidity because the seller does not exhibit a license when the exhibitor transfers the license to others by, for example, selling.

The same terminals 10 may mean that the authenticated users are the same and may not necessarily be limited to the same as hardware.

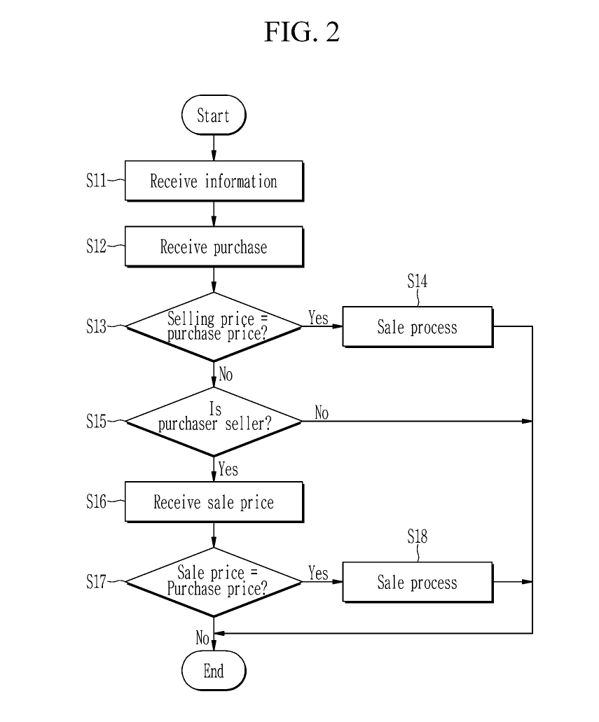

An intellectual property transaction processing executed by an intellectual property transaction system 1 is described with reference to FIG. 2. FIG. 2 is a diagram showing a flowchart of an intellectual property transaction processing executed by an intellectual property transaction system 1 according to an embodiment of the present invention. The processing executed by each module described above is described together with the present processing.

The information receiving unit 11 is a module achieved in an exhibitor's terminal (computer) 10, which receives the input of information on a license of intellectual property to be exhibited (step S11). The information may include a type, a name, a detail, and the number of licenses.

The type of a license of intellectual property to be exhibited is, for example, a patent if the license of intellectual property to be exhibited is a patent. Even if the intellectual property has a type other than a patent, the information receiving unit receives the information in the same way.

The name of a license of intellectual property to be exhibited is, for example, the title or the summary of invention if the license of intellectual property to be exhibited is a patent. Even if the intellectual property has a type other than a patent, the information receiving unit receives the information in the same way. The detail of a license of intellectual property to be exhibited is a specific embodiment such as a technical tangible object, method, or program.

The number of licenses of intellectual property to be exhibited is, for example, an exclusive license if the number of licenses is 1 or a non-exclusive license if the number is two or more if the license of intellectual property to be exhibited is a patent. The information may be determined in exhibitor's preference. Even if the intellectual property is a type other than a patent, the information receiving unit receives the information in the same way.

The purchase receiving unit 12 is a module achieved in a purchaser's terminal 10, which receives the input of a purchase price for a license of intellectual property to be purchased (step S12). For example, the license may be purchased at the limit order or the market order like stock trading. Two or more licenses of the same intellectual property can be purchased as desired. In this case, the probability that the licenses are granted to others can be reduced. Since the input of a desired purchase price is received, fluctuated liquidity is provided to licenses of intellectual property. The management computer 100 receives performs a sale process (step S14) if a selling price corresponds to the purchase price (step S13).

The sale receiving unit 13 is a module achieved in a seller's terminal 10, which receives the input of a sales price for a license of intellectual property to be sold among the purchased licenses of intellectual property (step S16). In other words, a seller who has not purchased and held any license of intellectual property cannot sell it (step S15). For example, the license to be sold may be received at the limit order or the market order like stock trading. Two or more purchased and held licenses of the same intellectual property may be sold. Since the input of a sales price is received, liquidity is provided to licenses of intellectual property.

The management computer 100 performs a sale process (step S18) if the sale price correspond to the purchase price (step S17). For example, if the system receives the input of one million yen as the sales price from the seller P who purchased the license a of intellectual property that the exhibitor P exhibited and the input of one million yen as the purchasing price from the purchaser R, a transaction of one million yen is made for the license a between the seller P and the purchaser R.

The bottom price receiving unit 14 is a module achieved in an exhibitor's terminal 10, which receives the bottom price of a license of intellectual property to be exhibited. For example, the input of purchase and sale is not received on a price less than the bottom price. This enables the license of intellectual property that is not popular among purchasers and sellers to keep a certain level of value by setting a bottom price.

The increase receiving unit 15 is a module to be achieved in a seller's terminal 10, which increases the number of licenses of the purchased intellectual property without permission from the exhibitor according to instruction from the seller. The seller's terminal 10 transmits the number of the increased licenses to the management computer 100, and then the management computer 100 stores it.

The seller's terminal 10 may achieve a change unit that changes the sales price based on the number of licenses. Specifically, the seller's terminal 10 confirms that the intended license is not an exclusive license but a non-exclusive license and then receives an increase in licenses. For example, since the price for one license can be reduced by increasing the number, the change process that reduces the sales price is performed. The seller's terminal 10 transmits the changed sales price to the management computer 100, and the management computer 100 stores it.

The change unit 16 may be achieved in the management computer 100. For example, the sales price may be calculated by learning according to the type, the detail, and the number of licenses. As the specific algorithm of the machine learning, the nearest neighbor algorithm, the naive Bayes algorithm, the decision tree, the support vector machine, etc. may be used. Furthermore, the machine learning may be the deep learning that generates the feature amount for learning by using the neural network.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

1. An intellectual property transaction system for transacting a license of intellectual property, comprising:
an information receiving unit that receives input of information on a license of intellectual property and a selling price for the license from an exhibitor's terminal;
a purchase receiving unit that receives input of a purchase price for the input information on the license of intellectual property from a purchaser's terminal;
an increase receiving unit that increases the number of licenses of the purchased intellectual property without permission from the exhibitor according to instruction from the seller if the purchaser becomes a seller; and
a sales receiving unit that receives input of a sales price for a license of intellectual property to be sold among the exhibited licenses of the intellectual property from a seller's terminal, wherein
the system performs a sale process for the purchaser if the selling price corresponds to the purchase price, and the system performs a sale process if the purchase price corresponds to the sales price.

2. The intellectual property transaction system according to claim 1, wherein the license of intellectual property is to practice at least one of a patent, a utility model right, and a design right among intellectual property rights.

3. The intellectual property transaction system according to claim 1, further comprising a bottom price receiving unit that receives input of a bottom price of the selling price or the sales price by the exhibitor's terminal or the seller's terminal, wherein the purchaser's terminal does not receive the input of purchase and sale on a price less than the bottom price.

4. (canceled)

5. The intellectual property transaction system according to claim 1, further comprising a change unit that calculates and changes the sales price of the increased number of licenses by learning according to the type, the detail, and the number of the licenses if the increase receiving unit increases the number of the licenses.

6. An intellectual property transaction method for transacting a license of intellectual property, comprising the steps of:
receiving input of information on a license of intellectual property and a selling price for the license from an exhibitor's terminal;
receiving input of a purchase price for the input information on the license of intellectual property from a purchaser's terminal;
performing a sale process for the purchaser if the selling price corresponds to the purchase price;
increasing the number of licenses of the purchased intellectual property without permission from the exhibitor according to instruction from the seller if the purchaser becomes a seller;
receiving input of a sales price for a license of intellectual property to be sold among the exhibited licenses of the intellectual property from a seller's terminal; and
performing a sale process if the purchase price corresponds to the sales price.

7. The intellectual property transaction method according to claim 6, further comprising the step of calculating and changing the sales price of the increased number of licenses by learning according to the type, the detail, and the number of the licenses if the number of the licenses is increased.
